(19) United States
(12) Patent Application Publication
(10) Pub. No.: US 2016/0369715 A1
(43) Pub. Date: Dec. 22, 2016

(54) CONTROL DEVICE FOR INTERNAL COMBUSTION ENGINE

(71) Applicant: TOYOTA JIDOSHA KABUSHIKI KAISHA, Toyota-shi (JP)

(72) Inventor: Kaoru OHTSUKA, Mishima-shi (JP)

(73) Assignee: TOYOTA JIDOSHA KABUSHIKI KAISHA, Toyota-shi (JP)

(21) Appl. No.: 15/185,881

(22) Filed: Jun. 17, 2016

(30) Foreign Application Priority Data
Jun. 17, 2015 (JP) 2015-121718

(51) Int. Cl. F02D 41/00; F02D 41/30; F01N 13/10; F02M 25/08

(52) U.S. Cl. CPC F02D 41/004; F02M 25/0836; F02M 25/089; F02D 41/0045; F02D 41/3094; F01N 13/10; F02D 2009/022

(57) ABSTRACT

In a control device for an internal combustion engine including a purge passage, and a purge control valve arranged in the purge passage, the control device includes a purge flow rate constancy control portion controlling an opening degree of the purge control valve so that a purge flow rate becomes constant, and a fuel injection amount control portion controlling a fuel injection amount. A request for switching from a stoichiometric combustion to a lean combustion occurs at a first time. A target air-fuel ratio is switched from a stoichiometric air-fuel ratio to a lean air-fuel ratio at a second time. A fuel injection amount control is executed during a period from the first time to the second time in a state in which the purge flow rate is maintained at a value at the first time.

### BACKGROUND OF THE DISCLOSURE

Field of the Disclosure

The present disclosure relates to a control device for an internal combustion engine having a purge passage that connects an intake passage and a fuel tank, and a purge control valve that is arranged in the purge passage.

Description of the Related Art

An evaporated fuel treatment apparatus for an internal combustion engine having a purge passage (piping) that connects an intake passage and a fuel tank, and a purge control valve (purge valve) that is arranged in the purge passage (piping) is known. The evaporated fuel treatment apparatus for the internal combustion engine is described in Japanese Patent Laid-Open No. 2004-052559.

In the evaporated fuel treatment apparatus for the internal combustion engine described in Japanese Patent Laid-Open No. 2004-052559, correction of a fuel injection amount is executed in accordance with a difference between a target air-fuel ratio and an actual air-fuel ratio.

In Japanese Patent Laid-Open No. 2004-052559, it is not described how a purge control should be executed during a period from a starting time of a throttle opening degree control that is based on a request for switching from a stoichiometric combustion to a lean combustion to a time when a target air-fuel ratio changes. Therefore, in the evaporated fuel treatment apparatus for the internal combustion engine described in Japanese Patent Laid-Open No. 2004-052559, there is a possibility that the difference between the target air-fuel ratio and the actual air-fuel ratio increases when a required air-fuel ratio increases.

When a throttle opening degree control starts on the basis of the request for switching from the stoichiometric combustion to the lean combustion, if a purge ratio constancy control is continued so that a purge ratio at a time when the throttle opening degree control starts is maintained, a response delay of the purge control occurs, accordingly, it becomes difficult to accurately control the fuel injection amount. Consequently, the difference between the target air-fuel ratio and the actual air-fuel ratio increases. That is, the actual air-fuel ratio deviates from the target air-fuel ratio.

On the other hand, when the throttle opening degree control starts on the basis of the request for switching from the stoichiometric combustion to the lean combustion, if a purge cut is executed to facilitate an accurate fuel injection amount control, although the difference between the target air-fuel ratio and the actual air-fuel ratio can be reduced, a purge amount of a fuel vapor cannot be secured.

Switching from the stoichiometric combustion to the lean combustion may frequently occur depending on an operation by a driver. If the switching from the stoichiometric combustion to the lean combustion occurs frequently, and if the purge cut is executed whenever the switching from the stoichiometric combustion to the lean combustion occurs, the purge amount of the fuel vapor cannot be secured, and therefore, there is a possibility that a fuel odor occurs.

### SUMMARY OF THE DISCLOSURE

An object of the present disclosure is to provide a control device for an internal combustion engine that can secure a purge amount of a fuel vapor and that can reduce a difference between a target air-fuel ratio and an actual air-fuel ratio, when switching from a stoichiometric combustion to a lean combustion is executed.

The present disclosure provides a control device for an internal combustion engine comprising:

a cylinder;

an intake passage that is connected to the cylinder;

a fuel tank;

a purge passage that connects the intake passage and the fuel tank;

a purge control valve that is arranged in the purge passage;

a fuel injection valve; and

a throttle valve, wherein the control device comprises:

a purge flow rate constancy control portion that controls an opening degree of the purge control valve, so that a purge flow rate becomes constant, wherein the purge flow rate is a flow rate of a purge gas that is purged into the intake passage through the purge control valve, and

a fuel injection amount control portion that controls an amount of fuel that is injected from the fuel injection valve,

wherein a throttle opening degree control is started at a first time on the basis of a request for switching from a stoichiometric combustion to a lean combustion, wherein an air amount is switched from an air amount that is necessary for the stoichiometric combustion to an air amount that is necessary for the lean combustion in the throttle opening degree control at the first time,

wherein a fuel injection amount control is executed at a second time when a target air-fuel ratio is switched from a stoichiometric air-fuel ratio to a lean air-fuel ratio, wherein a fuel injection amount is switched from a fuel injection amount that is necessary for the stoichiometric combustion to a fuel injection amount that is necessary for the lean combustion in the fuel injection amount control at the second time,

wherein the control device executes the fuel injection amount control during a period from the first time to the second time in a state in which the purge flow rate is maintained at a value of the purge flow rate at the first time.

That is, according to the control device for the internal combustion engine of the present disclosure, a purge cut is not executed during the period from the first time to the second time, wherein the throttle opening degree control is started at the first time in order to switch the air amount that is necessary for the stoichiometric combustion to the air amount that is necessary for the lean combustion, and wherein the target air-fuel ratio is switched from the stoichiometric air-fuel ratio to the lean air-fuel ratio at the second time.

Therefore, according to the control device for the internal combustion engine of the present disclosure, during the period from the first time to the second time, the purge amount of the fuel vapor can be secured and a possibility that a fuel odor occurs can be reduced.

More specifically, according to the control device for the internal combustion engine of the present disclosure, during the period from the first time to the second time, the purge cut is not executed, and the purge flow rate constancy control is executed, wherein the purge flow rate is maintained at the value of the purge flow rate at the first time in the purge flow rate constancy control.

Therefore, according to the control device for the internal combustion engine of the present disclosure, during the period from the first time to the second time, a concentration of the purge gas becomes constant and estimation errors in the concentration of the purge gas decrease. As a result, during the period from the first time to the second time, fluctuations in the actual air-fuel ratio that are caused by fluctuations in the concentration of the purge gas are suppressed.

In addition, according to the control device for the internal combustion engine of the present disclosure, during the period from the first time to the second time, the fuel injection amount is controlled in a state in which the fluctuations in the actual air-fuel ratio that are caused by the fluctuations in the concentration of the purge gas are suppressed.

Therefore, according to the control device for the internal combustion engine of the present disclosure, the difference between the target air-fuel ratio and the actual air-fuel ratio can be decreased more than in a case where the fuel injection amount is controlled in a state in which the fluctuations in the actual air-fuel ratio that are caused by the fluctuations in the concentration of the purge gas are not suppressed.

That is, according to the control device for the internal combustion engine of the present disclosure, when the switching from the stoichiometric combustion to the lean combustion is executed, the purge amount of the fuel vapor can be secured and the difference between the target air-fuel ratio and the actual air-fuel ratio can be decreased in an accurate fuel injection amount control.

The control device for the internal combustion engine of the present disclosure may further comprise a purge ratio constancy control portion that controls a purge ratio so as to be constant, wherein the purge ratio is a ratio of the purge flow rate to an intake air amount, wherein the control device starts a purge ratio constancy control after the second time.

That is, according to the control device for the internal combustion engine of the present disclosure, after the second time when the target air-fuel ratio is switched from the stoichiometric air-fuel ratio to the lean air-fuel ratio, the purge ratio constancy control is started, wherein even if the intake air amount changes, the fluctuations in the actual air-fuel ratio that are caused by the purge gas are suppressed in the purge ratio constancy control.

Therefore, according to the control device for the internal combustion engine of the present disclosure, by executing the purge flow rate constancy control during the period from the first time to the second time, a response delay of a purge control can be suppressed and the difference between the target air-fuel ratio and the actual air-fuel ratio can be reduced, wherein the fuel injection amount is changed during the period from the first time to the second time. Furthermore, according to the control device for the internal combustion engine of the present disclosure, by starting the purge ratio constancy control after the period from the first time to the second time, the fluctuations in the actual air-fuel ratio that are caused by the purge gas can be suppressed and the difference between the target air-fuel ratio and the actual air-fuel ratio can be reduced.

According to the control device for the internal combustion engine of the present disclosure, when the switching from the stoichiometric combustion to the lean combustion is executed, the purge amount of the fuel vapor can be secured and the difference between the target air-fuel ratio and the actual air-fuel ratio can be reduced.

Furthermore, according to the control device for the internal combustion engine of the present disclosure, the response delay of the purge control can be suppressed and the difference between the target air-fuel ratio and the actual air-fuel ratio can be reduced, during the period from the first time to the second time in which the fuel injection amount is changed, and after the period from the first time to the second time, the fluctuations in the actual air-fuel ratio that are caused by the purge gas can be suppressed and the difference between the target air-fuel ratio and the actual air-fuel ratio can be reduced.

### BRIEF DESCRIPTION OF THE DRAWINGS

FIG. 1 is a schematic configuration diagram of an engine system, to which a control device for an internal combustion engine of a first embodiment is applied;

FIG. 2 is a view illustrating functions of the control device 40 shown in FIG. 1;

FIG. 3A represents a required torque;

FIG. 3B represents a required air-fuel ratio;

FIG. 3C represents a throttle opening degree that is calculated by means of an air inverse model;

FIG. 3D represents an estimated KL (an estimated value of an in-cylinder intake air amount that is realized by an actual throttle opening degree) that is calculated by means of an air model;

FIG. 3E represents a target air-fuel ratio that is obtained through a combustion securing guard portion based on the required air-fuel ratio;

FIG. 3F represents an ignition timing of a spark plug 7 that is calculated based on an estimated torque;

FIG. 4A represents the required torque;

FIG. 4B represents the required air-fuel ratio;

FIG. 4C represents the throttle opening degree that is calculated by means of the air inverse model;

FIG. 4D represents the estimated KL (the estimated value of the in-cylinder intake air amount that is realized by the actual throttle opening degree) that is calculated by means of the air model;

FIG. 4E represents the target air-fuel ratio that is obtained through the combustion securing guard portion based on the required air-fuel ratio;

FIG. 4F represents the ignition timing of the spark plug 7 that is calculated based on the estimated torque;

FIG. 4G represents the purge ratio;

FIG. 4H represents the fuel injection amount;

FIG. 4I represents the purge flow rate (a purge gas amount);

FIG. 4J represents a purge control;

FIG. 5 is a flowchart of the purge control that is executed by the control device for the internal combustion engine of the first embodiment;

FIG. 6A represents the required torque;

FIG. 6B represents the required air-fuel ratio;

FIG. 6C represents the throttle opening degree that is calculated by means of the air inverse model;

FIG. 6D represents the estimated KL (the estimated value of the in-cylinder intake air amount that is realized by the actual throttle opening degree) that is calculated by means of the air model;

FIG. 6E represents the target air-fuel ratio that is obtained through the combustion securing guard portion based on the required air-fuel ratio;

FIG. 6F represents the ignition timing of the spark plug 7 that is calculated based on the estimated torque;

FIG. 6G represents the purge ratio;

FIG. 6H represents the fuel injection amount;

FIG. 6I represents the purge flow rate (the purge gas amount);

FIG. 6J represents the purge control;

FIG. 7A represents the required torque;

FIG. 7B represents the required air-fuel ratio;

FIG. 7C represents the throttle opening degree that is calculated by means of the air inverse model;

FIG. 7D represents the estimated KL (the estimated value of the in-cylinder intake air amount that is realized by the actual throttle opening degree) that is calculated by means of the air model;

FIG. 7E represents the target air-fuel ratio that is obtained through the combustion securing guard portion based on the required air-fuel ratio;

FIG. 7F represents the ignition timing of the spark plug 7 that is calculated based on the estimated torque;

FIG. 7G represents the purge ratio;

FIG. 7H represents the fuel injection amount;

FIG. 7I represents the purge flow rate (the purge gas amount); and

FIG. 7J represents the purge control.

### DETAILED DESCRIPTION OF THE PREFERRED EMBODIMENTS

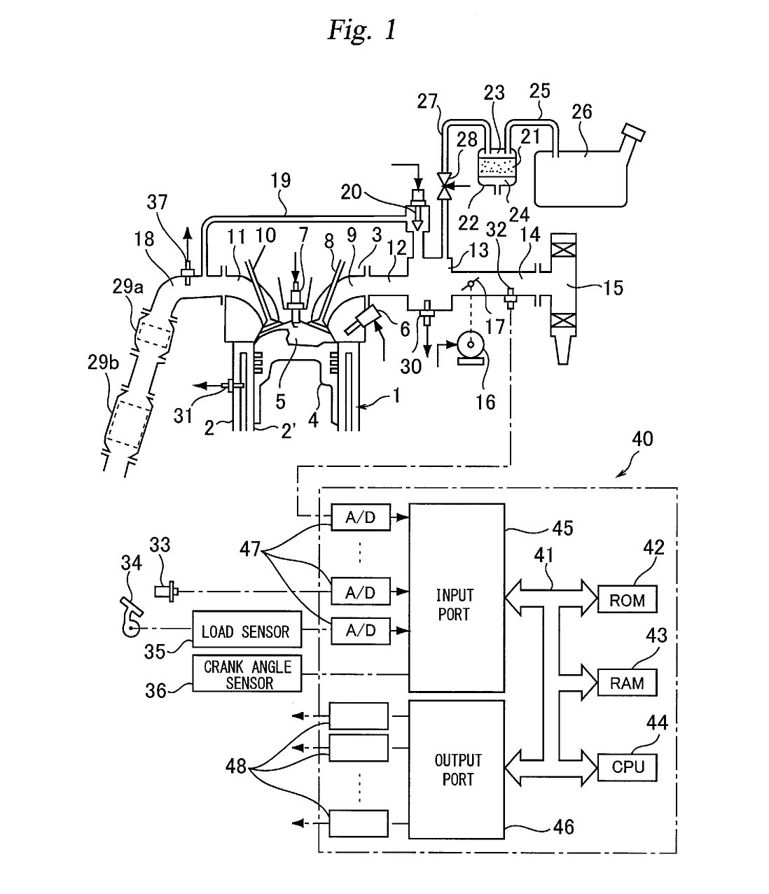

Hereunder, a first embodiment of a control device for an internal combustion engine of the present disclosure is described. FIG. 1 is a schematic configuration diagram of an engine system, to which the control device for the internal combustion engine of the first embodiment is applied.

In an example illustrated in FIG. 1, a cylinder block 2 and a cylinder head 3 are provided in an internal combustion engine main body 1. Although only one cylinder 2′ is shown in FIG. 1, a plurality of the cylinders are formed in the cylinder block 2. A piston 4 is arranged inside each of the cylinders. A combustion chamber 5 is formed by a top face of the piston 4, an inner circumferential face of the cylinder 2′, and a bottom face of the cylinder head 3. A fuel injection valve 6 and a spark plug 7 are arranged in the cylinder head 3.

Although in the example illustrated in FIG. 1, fuel is directly injected into the combustion chamber 5 from the fuel injection valve 6, in another example, it is also possible to inject fuel into an intake port 9 from a fuel injection valve arranged in the intake port 9.

Further, in the example illustrated in FIG. 1, the cylinder 2′ and an intake passage are connected, and the cylinder 2′ and an exhaust passage are connected. An intake valve 8 is arranged between the intake port 9 that constitutes a part of the intake passage, and the cylinder 2′. An exhaust valve 10 is arranged between an exhaust port 11 that constitutes a part of the exhaust passage, and the cylinder 2′. A surge tank 13 that constitutes a part of the intake passage is connected to the intake port 9 through an intake branch pipe 12 that constitutes a part of the intake passage. An air cleaner 15 is connected to the surge tank 13 through an intake duct 14 that constitutes a part of the intake passage. A throttle valve 17 that is driven by a step motor 16 is arranged in the intake duct 14.

In addition, in the example illustrated in FIG. 1, the exhaust port 11 is connected to an exhaust manifold 18 that constitutes a part of the exhaust passage. The exhaust manifold 18 and the surge tank 13 are connected by an EGR passage 19. An EGR control valve 20 is arranged in the EGR passage 19.

In the example illustrated in FIG. 1, a canister 22 is provided that contains an activated carbon 21. A fuel vapor chamber 23 is formed on one side of the activated carbon 21, and an atmospheric chamber 24 is formed on the other side of the activated carbon 21. The fuel vapor chamber 23 is connected to a fuel tank 26 through a conduit 25 that constitutes a part of a purge passage. The fuel vapor chamber 23 is also connected to the surge tank 13 that constitutes the part of the intake passage through a conduit 27 that constitutes a part of the purge passage. A purge control valve 28 that is controlled by an output signal of the control device (ECU (electronic control unit)) 40 is arranged in the conduit 27. Fuel vapor that is generated in the fuel tank 26 is sent through the conduit 25 into the canister 22 where it is adsorbed by the activated carbon 21. When the purge control valve 28 opens, air is sent from the atmospheric chamber 24 through the activated carbon 21 into the conduit 27. When the air passes through the activated carbon 21, the fuel vapor which is adsorbed in the activated carbon 21 is released from the activated carbon 21. As a result, a purge gas that is air containing the fuel vapor is purged through the conduit 27 into the surge tank 13.

Although in the example illustrated in FIG. 1 a purge control is applied to, for example, a gasoline engine system, the purge control can also be applied to, for example, a diesel engine system, in another example.

In the example illustrated in FIG. 1, for example, a catalytic converter 29a that houses a three-way catalyst is arranged in the exhaust passage. Another catalytic converter 29b is also arranged in the exhaust passage. An oxidation catalyst, a three-way catalyst, and a NOx occluding and reducing catalyst or a NOx selective reduction catalyst are arranged in the catalytic converter 29b, wherein the NOx occluding and reducing catalyst absorbs NOx when an air-fuel ratio is lean, and releases and reduces the absorbed NOx when the air-fuel ratio becomes rich, and wherein the NOx selective reduction catalyst reduces NOx under excess oxygen and in the presence of a large amount of unburned hydrocarbons.

In the example illustrated in FIG. 1, a ROM 42, a RAM 43, a CPU 44, an input port 45 and an output port 46 that are connected one another through a bidirectional bus 41 are provided in the control device 40. A pressure sensor 30 that generates an output voltage is arranged in the surge tank 13, wherein the output voltage is proportional to an absolute pressure in the surge tank 13. The output voltage of the pressure sensor 30 is input through a corresponding AD converter 47 to the input port 45. A water temperature sensor 31 that generates an output voltage that is proportional to temperature of cooling water is arranged in the internal combustion engine main body 1. The output voltage of the water temperature sensor 31 is input through a corresponding AD converter 47 to the input port 45. A temperature sensor 32 for detecting atmospheric temperature is arranged in the intake duct 14. An output signal of the temperature sensor 32 is input to the input port 45 through a corresponding AD converter 47.

Further, an output signal of an atmospheric pressure sensor 33 for detecting atmospheric pressure is input to the input port 45 through a corresponding AD converter 47. A load sensor 35 for generating an output voltage that is proportional to an amount of depression of an accelerator pedal 34 is connected to the accelerator pedal 34. The output voltage of the load sensor 35 is input to the input port 45 through a corresponding AD converter 47. A crank angle sensor 36 for generating an output pulse whenever a crank shaft (not shown) rotates by, for example, 30 degrees is also connected to the input port 45. Further, an air-fuel ratio sensor 37 is arranged in the exhaust manifold 18. An output signal of the air-fuel ratio sensor 37 is input through a corresponding AD converter 47 to the input port 45. In addition, an air flow meter (not shown) for detecting an intake air amount is arranged in the intake passage. An output signal of the air flow meter is input through a corresponding AD converter (not shown) to the input port 45.

The output port 46 is connected through corresponding drive circuits 48 to the fuel injection valve 6, the spark plug 7, the step motor 16, the EGR control valve 20 and the purge control valve 28.

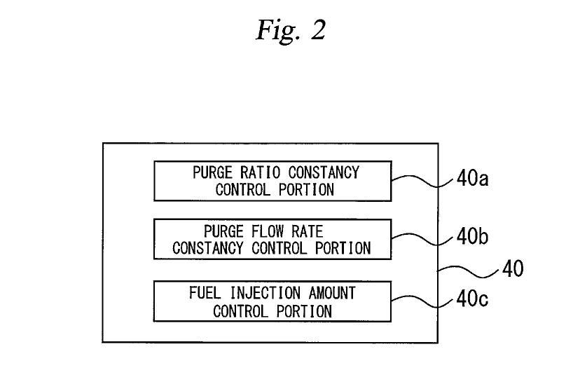

FIG. 2 is a view illustrating functions of the control device 40 shown in FIG. 1. In the engine system in which the control device for the internal combustion engine of the first embodiment is applied, as shown in FIG. 2, a purge flow rate constancy control portion 40b is provided in the control device 40, wherein the purge flow rate constancy control portion 40b controls an opening degree of the purge control valve 28 (see FIG. 1) so that a purge flow rate is constant, wherein the purge flow rate is a flow rate of the purge gas that is purged through the purge control valve 28 into the surge tank 13 that constitutes a part of the intake passage. A fuel injection amount control portion 40c that controls an amount of fuel that is injected from the fuel injection valve 6 (see FIG. 1), and a purge ratio constancy control portion 40a that controls a purge ratio so as to be constant are provided in the control device 40, wherein the purge ratio is a ratio of the purge flow rate to the intake air amount.

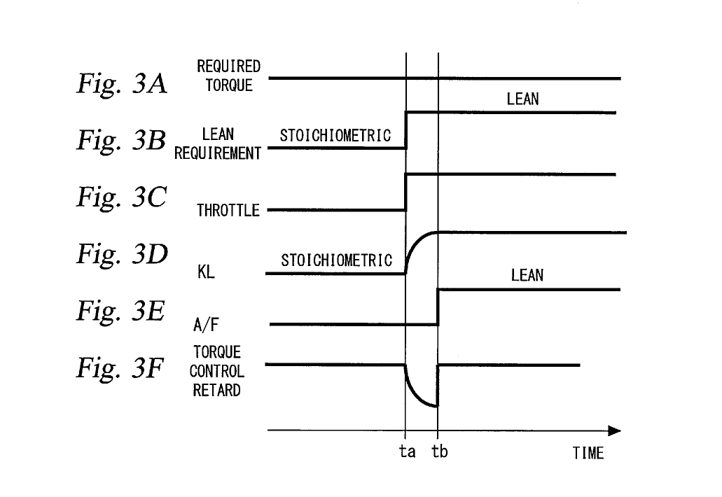

Before describing a control by the control device for the internal combustion engine of the first embodiment, points to be taken into account when the purge control is executed will be described. FIG. 3 is a time chart for describing the points to be taken into account when the purge control is executed. Specifically, FIG. 3A represents a required torque (for example, a load detected by the load sensor 35), FIG. 3B represents a required air-fuel ratio (specifically, existence/non-existence of a lean request (a request for switching from a stoichiometric combustion to a lean combustion)), FIG. 3C represents a throttle opening degree that is calculated by means of an air inverse model, FIG. 3D represents an estimated KL (an estimated value of an in-cylinder intake air amount that is realized by an actual throttle opening degree) that is calculated by means of an air model, FIG. 3E represents a target air-fuel ratio that is obtained through a combustion securing guard portion based on the required air-fuel ratio, and FIG. 3F represents an ignition timing of the spark plug 7 that is calculated based on an estimated torque.

In the example illustrated in FIG. 3, while the required torque (see FIG. 3A) is maintained at a constant value, the lean request (see FIG. 3B) is outputted at a time ta. That is, as shown in FIG. 3B, at the time ta, the request for switching from the stoichiometric combustion to the lean combustion is generated, and the required air-fuel ratio is switched from a stoichiometric air-fuel ratio to a lean air-fuel ratio. In addition, as shown in FIG. 3C, at the time ta, a control for increasing the throttle opening degree starts.

As shown in FIG. 3D, because a speed of change in the estimated KL is slower than a speed of change in the throttle opening degree (see FIG. 3C), an increase in the estimated KL starts at the time ta and ends at a time tb.

In the example illustrated in FIG. 3 in which the required air-fuel ratio is switched from the stoichiometric air-fuel ratio to the lean air-fuel ratio, before the time tb when the increase in the estimated KL ends, the target air-fuel ratio (see FIG. 3E) is maintained at the stoichiometric air-fuel ratio by the combustion securing guard portion. Furthermore, the target air-fuel ratio is switched from the stoichiometric air-fuel ratio to the lean air-fuel ratio at the time tb when the increase in the estimated KL ends.

In addition, in the example illustrated in FIG. 3, during a period from the time ta to the time tb, a control for retarding the ignition timing (see FIG. 3F) is executed, so that even if the estimated KL increases, the torque does not increase but is kept constant. Further, at the time tb, a control for advancing the ignition timing (that is, a control for returning a retarded ignition timing to an original ignition timing) is executed.

In the example illustrated in FIG. 3, the throttle opening degree (see FIG. 3C) increases sharply at the time ta, and the increase in the estimated KL (see FIG. 3D) starts at the time ta and ends at the time tb. That is, it takes the period (tb-ta) for the change in the estimated KL.

A period from a time when the opening degree of the purge control valve 28 (see FIG. 1) increases sharply to a time when an increase in the purge flow rate ends, is necessary for a change in the purge flow rate, and is a response delay of the purge control, wherein the purge flow rate is the flow rate of the purge gas that is purged into the intake passage (the surge tank 13 in the example shown in FIG. 1). The period, which is the response delay of the purge control, is longer than the period (tb-ta), wherein the period (tb-ta) is necessary for the change in the estimated KL.

That is, even if it is attempted to change the purge flow rate in accordance with the change in the estimated KL, in practice, a speed of change in the purge flow rate is slower than the speed of the change in the estimated KL. Therefore, a speed of change in the purge ratio cannot be controlled equally to the speed of the change in the estimated KL, wherein the purge ratio is the ratio of the purge flow rate to the intake air amount.

Consequently, during the period from the time ta to the time tb while the estimated KL is changing, if, for example, a purge ratio constancy control is executed based on the purge ratio, an actual air-fuel ratio diverges from the target air-fuel ratio shown in FIG. 3E. As a result, controllability of the air-fuel ratio decreases and torque controllability decreases. That is, even if the required torque is kept constant as shown in FIG. 3A, in practice, torque fluctuations occur and drivability deteriorates.

Further, in the example illustrated in FIG. 3E, at the time tb, a fuel injection amount sharply decreases in response to a change in the target air-fuel ratio from the stoichiometric air-fuel ratio to the lean air-fuel ratio.

On the other hand, the period (the response delay of the purge control) from the time when the opening degree of the purge control valve 28 (see FIG. 1) changes to the time when the change in the purge flow rate ends, is remarkably longer than a period which is necessary for a sharp decrease in the fuel injection amount.

That is, even if it is attempted to change the purge flow rate in accordance with a change in the fuel injection amount, in practice, the speed of the change in the purge flow rate is slower than a speed of the change in the fuel injection amount. Therefore, the speed of the change in the purge ratio cannot be controlled equally to the speed of the change in the fuel injection amount.

Consequently, at the time tb when the fuel injection amount sharply decreases, if, for example, the purge control is executed based on the purge ratio, the actual air-fuel ratio diverges from the target air-fuel ratio shown in FIG. 3E. As a result, the controllability of the air-fuel ratio decreases and the torque controllability decreases. That is, even if the required torque is kept constant as shown in FIG. 3A, in practice, the torque fluctuations occur and the drivability deteriorates.

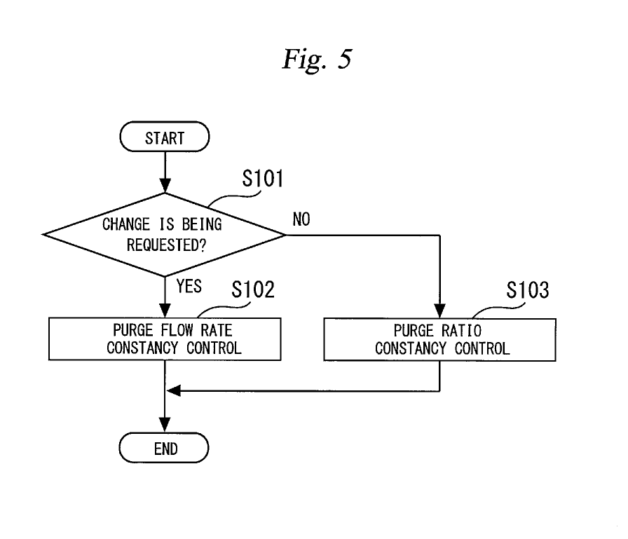

In consideration of the foregoing points, according to the control device for the internal combustion engine of the first embodiment, the purge control that is illustrated in FIG. 5 is executed. FIG. 5 is a flowchart of the purge control that is executed by the control device for the internal combustion engine of the first embodiment.

A routine illustrated in FIG. 5 is executed at predetermined time intervals. Upon the start of the routine illustrated in FIG. 5, first, in step S101, it is determined whether or not a change from the stoichiometric air-fuel ratio to the lean air-fuel ratio is being requested. (Specifically, while the change from the stoichiometric air-fuel ratio to the lean air-fuel ratio is requested, the actual air-fuel ratio is stoichiometric and the required air-fuel ratio is lean.) A period while the change from the stoichiometric air-fuel ratio to the lean air-fuel ratio is requested, corresponds to, such as the period from the time ta to the time tb in FIG. 3B. (Specifically, the period includes the time tb.) When the actual air-fuel ratio is stoichiometric and when the required air-fuel ratio is lean, the result determined in step S101 is “Yes”, and the process proceeds to step S102. In contrast, if “No” is determined as the result in step S101, the process proceeds to step S103.

When “Yes” is determined as the result in step S101, because an intake air amount control is executed in which the estimated KL changes sharply, as in the period from the time ta to the time tb in FIG. 3D, the response delay of the purge control is taken into account. Furthermore, when “Yes” is determined as the result in step S101, because a fuel injection amount control is executed in which the fuel injection amount sharply decreases, as at the time tb in FIG. 3, the response delay of the purge control is taken into account. Therefore, in step S102, the purge control is switched from the purge ratio constancy control to a purge flow rate constancy control. Specifically, the opening degree of the purge control valve 28 (see FIG. 1) is controlled by the purge flow rate constancy control portion 40b (see FIG. 2) so that the purge flow rate becomes constant, wherein the purge flow rate is the flow rate of the purge gas that is purged into the intake passage through the purge control valve 28.

More specifically, a duty ratio of the purge control valve 28 is set to a ratio of a purge flow rate that should be maintained constant to a full-open purge flow rate that is a purge flow rate when the purge control valve 28 is fully open. The full-open purge flow rate increases, as a negative pressure in the intake branch pipe 12 (see FIG. 1) increases.

In step S103, the opening degree of the purge control valve 28 is controlled by the purge ratio constancy control portion 40a (see FIG. 2) so that the purge ratio becomes constant, wherein the purge ratio is the ratio of the purge flow rate to the intake air amount.

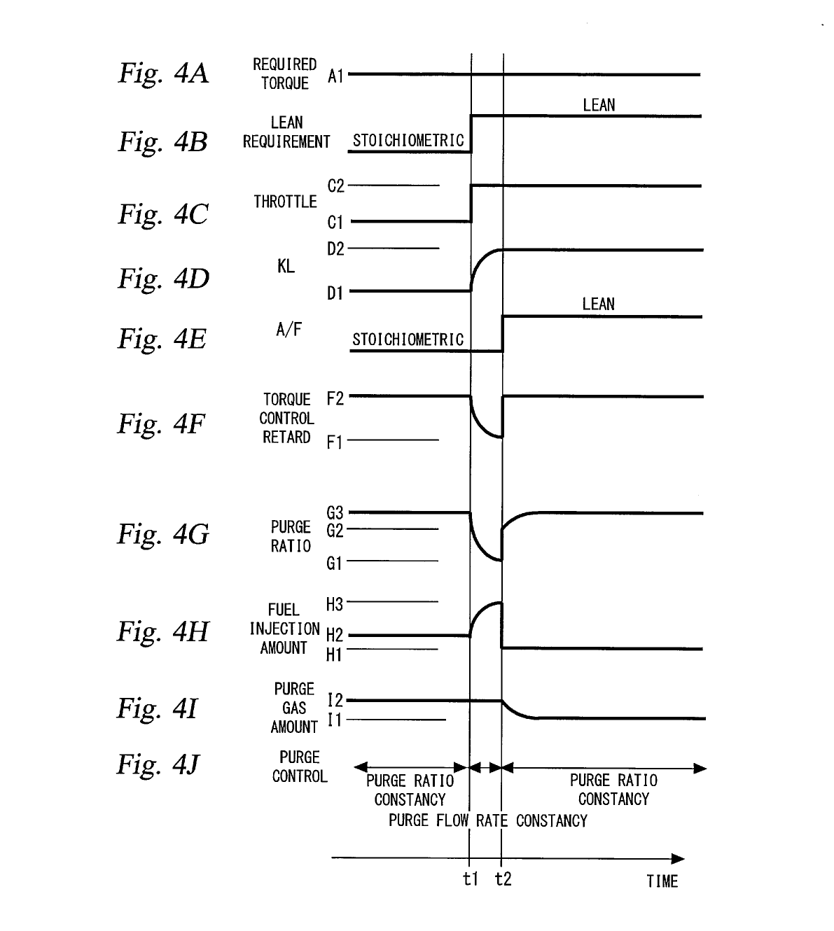

FIG. 4 is a time chart illustrating one example in which the purge flow rate constancy control is executed by the control device for the internal combustion engine of the first embodiment. Specifically, FIG. 4A represents the required torque (for example, the load detected by the load sensor 35 (see FIG. 1)), FIG. 4B represents the required air-fuel ratio (specifically, existence/non-existence of the lean request (the request for switching from the stoichiometric combustion to the lean combustion)), FIG. 4C represents the throttle opening degree that is calculated by means of the air inverse model, FIG. 4D represents the estimated KL (the estimated value of the in-cylinder intake air amount that is realized by the actual throttle opening degree) that is calculated by means of the air model, FIG. 4E represents the target air-fuel ratio that is obtained through the combustion securing guard portion based on the required air-fuel ratio, and FIG. 4F represents the ignition timing of the spark plug 7 that is calculated based on the estimated torque. FIG. 4G represents the purge ratio, FIG. 4H represents the fuel injection amount, FIG. 4I represents the purge flow rate (a purge gas amount), and FIG. 4J represents the purge control.

In the example illustrated in FIG. 4, in a period up to a time t1, the required torque (see FIG. 4A) is maintained at a value A1, the required air-fuel ratio (see FIG. 4B) is set to the stoichiometric air-fuel ratio, the throttle opening degree (see FIG. 4C) is maintained at a value C1, the estimated KL (see FIG. 4D) is maintained at a value D1, the fuel injection amount (see FIG. 4H) is maintained at a value H2, and the target air-fuel ratio (see FIG. 4E) is maintained at the stoichiometric air-fuel ratio.

In the period up to the time t1 in which the estimated KL does not change and the fuel injection amount does not change, since it is not necessary to take the response delay of the purge control into account, in the example illustrated in FIG. 4 in which the control device for the internal combustion engine of the first embodiment is applied, “No” is determined as the result in step S101 (see FIG. 5), and therefore, as shown in FIG. 4J, the purge ratio constancy control (step S103 (see FIG. 5)) is executed. Specifically, the purge ratio (see FIG. 4G) is maintained at a value G3. In addition, the purge flow rate (see FIG. 4I) which is the product of the purge ratio and the intake air amount is maintained at a value I2. The ignition timing (see FIG. 4F) is set to a value F2.

In the example illustrated in FIG. 4, while the required torque (see FIG. 4A) is maintained at the value A1, the lean request (see FIG. 4B) is outputted at the time t1. That is, as shown in FIG. 4B, at the time t1, the request for switching from the stoichiometric combustion to the lean combustion is generated, and the required air-fuel ratio is switched from the stoichiometric air-fuel ratio to the lean air-fuel ratio. In accompaniment therewith, as shown in FIG. 4C, at the time t1, the control for increasing the throttle opening degree from the value C1 to a value C2 starts.

Because the speed of the change in the estimated KL (see FIG. 4D) is slower than the speed of the change in the throttle opening degree (see FIG. 4C), as shown in FIG. 4D, the increase in the estimated KL from the value D1 to a value D2 starts at the time t1 and ends at a time t2.

In comparison to switching of the required air-fuel ratio from the stoichiometric air-fuel ratio to the lean air-fuel ratio (see FIG. 4B), switching of the target air-fuel ratio from the stoichiometric air-fuel ratio to the lean air-fuel ratio (see FIG. 4E) is delayed by the combustion securing guard portion by a delay time that corresponds to a period from the time t1 when the increase in the estimated KL starts to the time t2 when the increase in the estimated KL ends. Further, during the period from the time t1 to the time t2, based on the target air-fuel ratio (see FIG. 4E) that is being maintained at the stoichiometric air-fuel ratio, the fuel injection amount (see FIG. 4H) increases to a value H3 from the value H2 in correspondence with the increase in the estimated KL.

In addition, in the example illustrated in FIG. 4, during the period from the time t1 to the time t2, the control for retarding the ignition timing (see FIG. 4F) from the value F2 to a value F1 is executed, so that even if the estimated KL and the fuel injection amount increase, the torque does not increase and is maintained at the value A1 (see FIG. 4A).

On the other hand, in the example illustrated in FIG. 4 in which the control device for the internal combustion engine of the first embodiment is applied, the response delay of the purge control with respect to the increase in the estimated KL and the increase in the fuel injection amount is taken into account, and during the period from the time t1 to the time t2 the result determined in step S101 (see FIG. 5) is “Yes”, and as shown in FIG. 4J, the purge flow rate constancy control (step S102 (see FIG. 5)) is executed. Specifically, as shown in FIG. 4I, during the period from the time t1 to the time t2, the value I2 of the purge flow rate (the purge gas amount) at the time t1 is maintained.

Furthermore, during the period from the time t1 to the time t2, as shown in FIG. 4G, the purge ratio that is the ratio of the purge flow rate to the intake air amount decreases from the value G3 to a value G1 in correspondence with an increase in the intake air amount that accompanies an increase in the throttle opening degree (see FIG. 4C).

In the example illustrated in FIG. 4, at the time t2 when the increase in the estimated KL (see FIG. 4D) ends (the time t2 when a guard by the combustion securing guard portion ends), the target air-fuel ratio (see FIG. 4E) is switched from the stoichiometric air-fuel ratio to the lean air-fuel ratio, and the fuel injection amount (see FIG. 4H) decreases from the value H3 to a value H1.

That is, in the example illustrated in FIG. 4, the lean combustion is executed from the time t2 onwards.

In the example illustrated in FIG. 4 in which the control device for the internal combustion engine of the first embodiment is applied, the response delay of the purge control with respect to a rapid decrease in the fuel injection amount is taken into account, and at the time t2, “Yes” is determined as the result in step S101 (see FIG. 5), and therefore, as shown in FIG. 4J, the purge flow rate constancy control (step S102 (see FIG. 5)) is executed. Specifically, as shown in FIG. 4I, at the time t2, the value I2 of the purge flow rate (the purge gas amount) at the time t1 is maintained.

In addition, in the example illustrated in FIG. 4, at the time t2, the control for advancing the ignition timing (see FIG. 4F) from the value F1 to the value F2 (that is, the control for returning the retarded ignition timing to the original ignition timing) is executed.

In a period after the time t2 in which the estimated KL (see FIG. 4D) does not change, and the fuel injection amount (see FIG. 4H) does not change, since it is not necessary to take into account the response delay of the purge control, in the example illustrated in FIG. 4 in which the control device for the internal combustion engine of the first embodiment is applied, “No” is determined as the result in step S101 (see FIG. 5), and therefore, as shown in FIG. 4J, the purge ratio constancy control (step S103 (see FIG. 5)) is executed. Specifically, a target value of the purge ratio (see FIG. 4G) is set to the value G3. Upon the purge ratio becoming constant at the value G3, the purge flow rate (see FIG. 4I) which is the product of the purge ratio and the intake air amount becomes constant at a value I1.

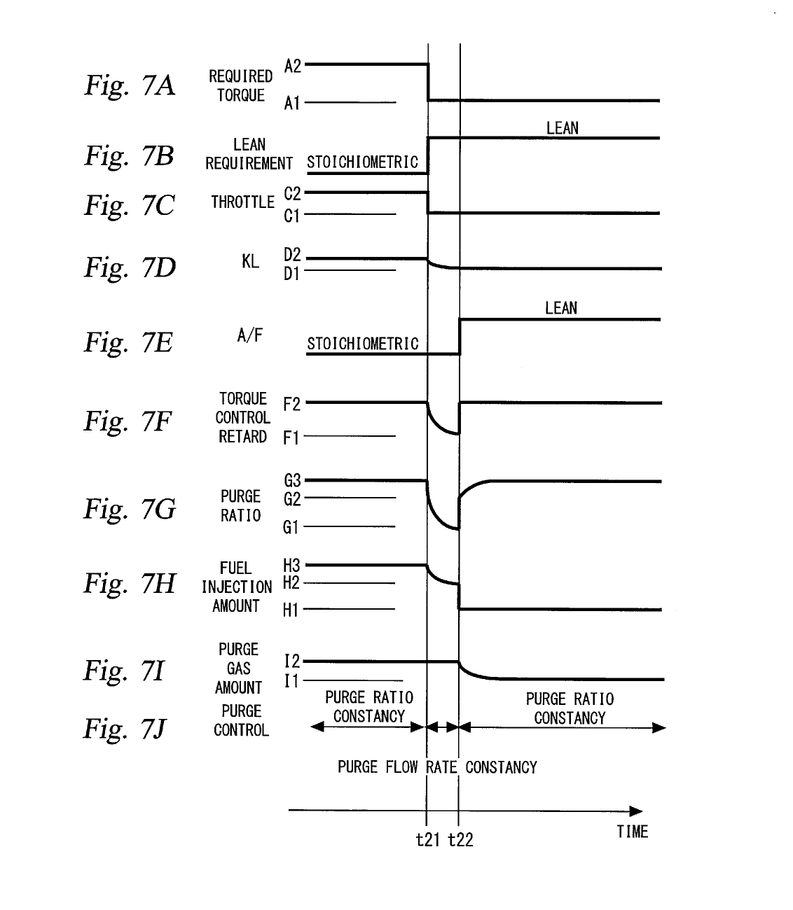

FIG. 7 is a time chart illustrating another example in which the purge flow rate constancy control is executed by the control device for the internal combustion engine of the first embodiment. Specifically, FIG. 7A represents the required torque (for example, the load detected by the load sensor 35 (see FIG. 1)), FIG. 7B represents the required air-fuel ratio (specifically, existence/non-existence of the lean request (the request for switching from the stoichiometric combustion to the lean combustion)), FIG. 7C represents the throttle opening degree that is calculated by means of the air inverse model, FIG. 7D represents the estimated KL (the estimated value of the in-cylinder intake air amount that is realized by the actual throttle opening degree) that is calculated by means of the air model, FIG. 7E represents the target air-fuel ratio that is obtained through the combustion securing guard portion based on the required air-fuel ratio, and FIG. 7F represents the ignition timing of the spark plug 7 that is calculated based on the estimated torque. FIG. 7G represents the purge ratio, FIG. 7H represents the fuel injection amount, FIG. 7I represents the purge flow rate (the purge gas amount), and FIG. 7J represents the purge control.

In the example illustrated in FIG. 7, in a period up to a time t21 in which the required torque (see FIG. 7A) is maintained at a value A2 and the required air-fuel ratio (see FIG. 7B) is set to the stoichiometric air-fuel ratio, the throttle opening degree (see FIG. 7C) is maintained at a value C2, the estimated KL (see FIG. 7D) is maintained at a value D2, and the fuel injection amount (see FIG. 7H) is maintained at a value H3. In addition, the target air-fuel ratio (see FIG. 7E) is maintained at the stoichiometric air-fuel ratio.

In the period up to the time t21 in which the estimated KL does not change, and the fuel injection amount does not change, since it is not necessary to take the response delay of the purge control into account, in the example illustrated in FIG. 7 in which the control device for the internal combustion engine of the first embodiment is applied, “No” is determined as the result in step S101 (see FIG. 5), and therefore, as shown in FIG. 7J, the purge ratio constancy control (step S103 (see FIG. 5)) is executed. Specifically, the purge ratio (see FIG. 7G) is maintained at a value G3. In addition, the purge flow rate (see FIG. 7I) which is the product of the purge ratio and the intake air amount is maintained at a value I2. The ignition timing (see FIG. 7F) is set to a value F2.

In the example illustrated in FIG. 7, the lean request (the request for switching from the stoichiometric combustion to the lean combustion) (see FIG. 7B) is outputted at the time t21 when the required torque (see FIG. 7A) decreases from the value A2 to a value A1. That is, as shown in FIG. 7B, at the time t21 the required air-fuel ratio is switched from the stoichiometric air-fuel ratio to the lean air-fuel ratio. Accompanying a decrease in the required torque from the value A2 to the value A1, as shown in FIG. 7C, at the time t21, a control for decreasing the throttle opening degree from the value C2 to a value C1 starts.

Because the speed of the change in the estimated KL (see FIG. 7D) is slower than the speed of the change in the throttle opening degree (see FIG. 7C), as shown in FIG. 7D, a decrease in the estimated KL from the value D2 to a value D1 starts at the time t21 and ends at a time t22.

In comparison to the switching of the required air-fuel ratio from the stoichiometric air-fuel ratio to the lean air-fuel ratio (see FIG. 7B), the switching of the target air-fuel ratio from the stoichiometric air-fuel ratio to the lean air-fuel ratio (see FIG. 7E) is delayed by the combustion securing guard portion by the delay time that corresponds to a period from the time t21 when the decrease in the estimated KL starts to the time t22 when the decrease in the estimated KL ends. Further, during the period from the time t21 to the time t22, based on the target air-fuel ratio (see FIG. 7E) that is being maintained at the stoichiometric air-fuel ratio, the fuel injection amount (see FIG. 7H) decreases from the value H3 to a value H2 in correspondence with the decrease in the estimated KL.

In addition, in the example illustrated in FIG. 7, during the period from the time t21 to the time t22, the control for retarding the ignition timing (see FIG. 7F) from the value F2 to a value F1 is executed.

On the other hand, in the example illustrated in FIG. 7 in which the control device for the internal combustion engine of the first embodiment is applied, the response delay of the purge control with respect to the decrease in the estimated KL and the decrease in the fuel injection amount is taken into account, and during the period from the time t21 to the time t22 the result determined in step S101 (see FIG. 5) is “Yes”, and as shown in FIG. 7J, the purge flow rate constancy control (step S102 (see FIG. 5)) is executed. Specifically, as shown in FIG. 7I, during the period from the time t21 to the time t22, the value I2 of the purge flow rate (the purge gas amount) at the time t21 is maintained.

In the example illustrated in FIG. 7, at the time t22 when the decrease in the estimated KL (see FIG. 7D) ends (at the time t22 when the guard by the combustion securing guard portion ends), the target air-fuel ratio (see FIG. 7E) is switched from the stoichiometric air-fuel ratio to the lean air-fuel ratio, and the fuel injection amount (see FIG. 7H) decreases from the value H2 to a value H1.

That is, in the example illustrated in FIG. 7, the lean combustion is executed from the time t22 onwards.

In the example illustrated in FIG. 7 in which the control device for the internal combustion engine of the first embodiment is applied, the response delay of the purge control with respect to the rapid decrease in the fuel injection amount is taken into account, and at the time t22, “Yes” is determined as the result in step S101 (see FIG. 5), and therefore, as shown in FIG. 7J, the purge flow rate constancy control (step S102 (see FIG. 5)) is executed. Specifically, as shown in FIG. 7I, at the time t22, the value I2 of the purge flow rate (the purge gas amount) at the time t21 is maintained.

In a period after the time t22 in which the estimated KL (see FIG. 7D) does not change, and the fuel injection amount (see FIG. 7H) does not change, since it is not necessary to take into account the response delay of the purge control, in the example illustrated in FIG. 7 in which the control device for the internal combustion engine of the first embodiment is applied, “No” is determined as the result in step S101 (see FIG. 5), and therefore, as shown in FIG. 7J, the purge ratio constancy control (step S103 (see FIG. 5)) is executed. Specifically, the target value of the purge ratio (see FIG. 7G) is set to the value G3. Upon the purge ratio becoming constant at the value G3, the purge flow rate (see FIG. 7I) which is the product of the purge ratio and the intake air amount becomes constant at a value I1.

In the example illustrated in FIG. 7, a change amount (D2−D1) in the estimated KL (see FIG. 7D) during the period from the time t21 to the time t22 is less than a change amount (D2−D1) in the estimated KL (see FIG. 4D) during the period from the time t1 to the time t2 in the example illustrated in FIG. 4. Consequently, in the example illustrated in FIG. 7, the period (t22−t21) in which the purge flow rate constancy control (step S102 (see FIG. 5)) is executed is shorter than the period (t2−t1) in which the purge flow rate constancy control is executed in the example illustrated in FIG. 4.

Therefore, in the example illustrated in FIG. 7, the period (t22−t21) in which the required air-fuel ratio (see FIG. 7B) and the target air-fuel ratio (see FIG. 7E) are different is shorter than the period (t2−t1) in which the required air-fuel ratio (see FIG. 4B) and the target air-fuel ratio (see FIG. 4E) are different in the example illustrated in FIG. 4, and thus the controllability of the air-fuel ratio is improved.

In other words, according to the control device for the internal combustion engine of the first embodiment, during a period from a first time (the time t1 in FIG. 4, and the time t21 in FIG. 7) when, based on the request for switching from the stoichiometric combustion to the lean combustion, the control of the throttle opening degree for switching from an air amount that is necessary for the stoichiometric combustion to an air amount that is necessary for the lean combustion starts, to a second time (the time t2 in FIG. 4, and the time t22 in FIG. 7) when the target air-fuel ratio is switched from the stoichiometric air-fuel ratio to the lean air-fuel ratio, the fuel injection amount is controlled in a state in which a value (the value I2 in FIG. 4I, and the value I2 in FIG. 7I) of the purge flow rate at the first time is maintained.

That is, according to the control device for the internal combustion engine of the first embodiment, a purge cut is not executed during the period from the first time when the control of the throttle opening degree for switching from the air amount that is necessary for the stoichiometric combustion to the air amount that is necessary for the lean combustion starts to the second time when the target air-fuel ratio is switched from the stoichiometric air-fuel ratio to the lean air-fuel ratio. Therefore, according to the control device for the internal combustion engine of the first embodiment, during the period from the first time to the second time, a purge amount of a fuel vapor can be secured, and a possibility that a fuel odor occurs can be reduced.

Specifically, according to the control device for the internal combustion engine of the first embodiment, during the period from the first time (the time t1 in FIG. 4, and the time t21 in FIG. 7) to the second time (the time t2 in FIG. 4, and the time t22 in FIG. 7), the purge cut is not executed and the purge flow rate constancy control (step S102 (see FIG. 5)) is executed, wherein a value of the purge flow rate at the first time is maintained in the purge flow rate constancy control. Therefore, according to the control device for the internal combustion engine of the first embodiment, during the period from the first time to the second time, a concentration of the purge gas is constant, and estimation errors in the concentration of the purge gas are reduced. As a result, during the period from the first time to the second time, fluctuations in the actual air-fuel ratio that are caused by fluctuations in the concentration of the purge gas are suppressed.

In addition, according to the control device for the internal combustion engine of the first embodiment, during the period from the first time (the time t1 in FIG. 4, and the time t21 in FIG. 7) to the second time (the time t2 in FIG. 4, and the time t22 in FIG. 7), the fuel injection amount is controlled in a state in which the fluctuations in the actual air-fuel ratio that are caused by the fluctuations in the concentration of the purge gas are suppressed. Therefore, according to the control device for the internal combustion engine of the first embodiment, a difference between the target air-fuel ratio and the actual air-fuel ratio can be reduced more than in a case where the fuel injection amount is controlled in a state in which the fluctuations in the actual air-fuel ratio that are caused by the fluctuations in the concentration of the purge gas are not suppressed.

That is, according to the control device for the internal combustion engine of the first embodiment, when switching from the stoichiometric combustion to the lean combustion is executed, the purge amount of the fuel vapor can be secured and the difference between the target air-fuel ratio and the actual air-fuel ratio can be decreased in an accurate fuel injection amount control.

Further, according to the control device for the internal combustion engine of the first embodiment, the purge ratio constancy control (step S103 (see FIG. 5)) is started after the second time (the time t2 in FIG. 4, and the time t22 in FIG. 7) when the target air-fuel ratio is switched from the stoichiometric air-fuel ratio to the lean air-fuel ratio.

That is, according to the control device for the internal combustion engine of the first embodiment, after the second time (time t2 in FIG. 4, and time t22 in FIG. 7) when the target air-fuel ratio is switched from the stoichiometric air-fuel ratio to the lean air-fuel ratio, the purge ratio constancy control (step S103 (see FIG. 5)) is started, wherein fluctuations in the actual air-fuel ratio that are caused by the purge gas are suppressed even if the intake air amount changes.

Therefore, according to the control device for the internal combustion engine of the first embodiment, by executing the purge flow rate constancy control (step S102 (see FIG. 5)) during the period from the first time (the time t1 in FIG. 4, and the time t21 in FIG. 7) to the second time (the time t2 in FIG. 4, and the time t22 in FIG. 7), the response delay of the purge control can be suppressed and the difference between the target air-fuel ratio and the actual air-fuel ratio can be reduced, wherein the fuel injection amount is changed during the period from the first time to the second time. Furthermore, according to the control device for the internal combustion engine of the first embodiment, by starting the purge ratio constancy control (step S103 (see FIG. 5)) after the period from the first time to the second time, the fluctuations in the actual air-fuel ratio that are caused by the purge gas can be suppressed and the difference between the target air-fuel ratio and the actual air-fuel ratio can be reduced.

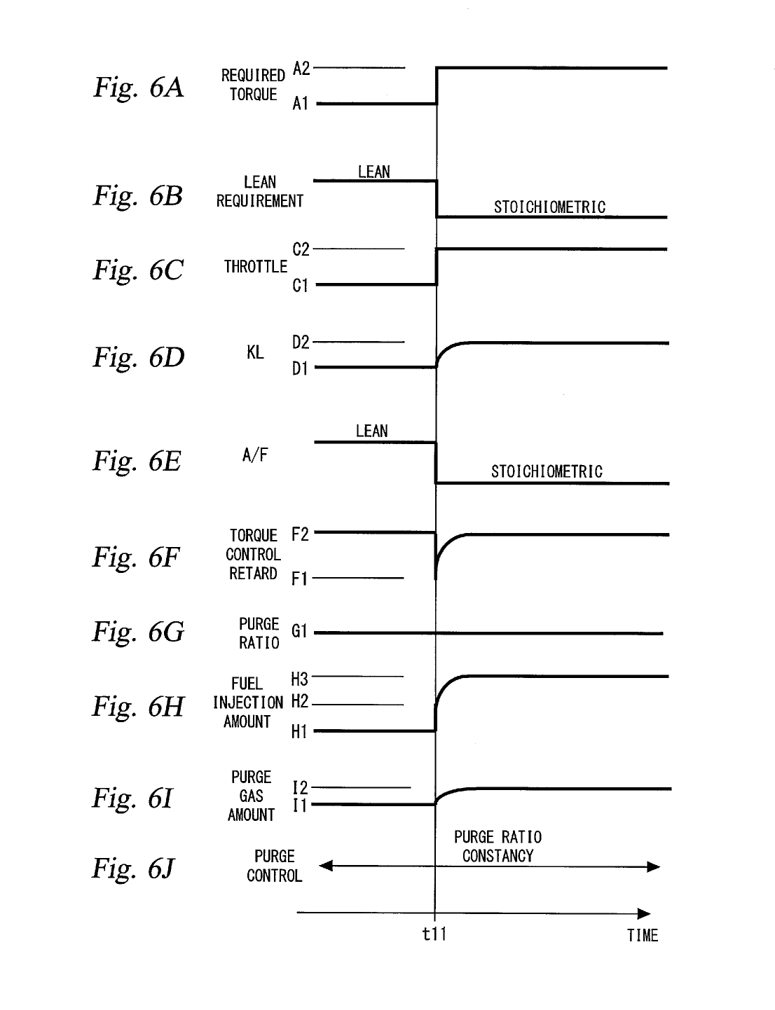

FIG. 6 is a time chart illustrating one example in which the purge flow rate constancy control is not executed in the control device for the internal combustion engine of the first embodiment. Specifically, FIG. 6A represents the required torque (for example, the load detected by the load sensor 35 (see FIG. 1)), FIG. 6B represents the required air-fuel ratio (specifically, existence/non-existence of a lean request (request to switch from stoichiometric combustion to lean combustion)), FIG. 6C represents the throttle opening degree that is calculated by means of the air inverse model, FIG. 6D represents the estimated KL (the estimated value of the in-cylinder intake air amount that is realized by the actual throttle opening degree) that is calculated by means of the air model, FIG. 6E represents the target air-fuel ratio that is obtained through the combustion securing guard portion based on the required air-fuel ratio, and FIG. 6F represents the ignition timing of the spark plug 7 that is calculated based on the estimated torque. FIG. 6G represents the purge ratio, FIG. 6H represents the fuel injection amount, FIG. 6I represents the purge flow rate (the purge gas amount), and FIG. 6J represents the purge control.

In the example illustrated in FIG. 6, in a period up to a time t11 in which the required torque (see FIG. 6A) is maintained at a value A1 and the required air-fuel ratio (see FIG. 6B) is set to the lean air-fuel ratio, the throttle opening degree (see FIG. 6C) is maintained at a value C1, the estimated KL (see FIG. 6D) is maintained at a value D1, and the fuel injection amount (see FIG. 6H) is maintained at a value H1. In addition, the target air-fuel ratio (see FIG. 6E) is maintained at the lean air-fuel ratio.

In the period up to the time t11 in which the estimated KL does not change and the fuel injection amount does not change, since it is not necessary to take the response delay of the purge control into account, in the example illustrated in FIG. 6 in which the control device for the internal combustion engine of the first embodiment is applied, “No” is determined as the result in step S101 (see FIG. 5), and therefore, as shown in FIG. 6J, purge ratio constancy control (step S103 (see FIG. 5)) is executed. Specifically, the purge ratio (see FIG. 6G) is maintained at a value G1. In addition, the purge flow rate (see FIG. 6I) which is the product of the purge ratio and the intake air amount is maintained at a value I1. The ignition timing (see FIG. 6F) is set to a value F2.

In the example illustrated in FIG. 6, the lean request (see FIG. 6B) disappears at the time t11 when the required torque (see FIG. 6A) increases from the value A1 to a value A2. That is, as shown in FIG. 6B, at the time t11, the request for switching from the lean combustion to the stoichiometric combustion occurs, and the required air-fuel ratio is switched from the lean air-fuel ratio to the stoichiometric air-fuel ratio. Accompanying the increase in the required torque from the value A1 to the value A2, as shown in FIG. 6C, at the time t11, the control for increasing the throttle opening degree from the value C1 to a value C2 starts. As a result, as shown in FIG. 6D, the increase in the estimated KL from the value D1 to a value D2 starts at the time t11.

In the combustion securing guard portion, when the required air-fuel ratio (see FIG. 6B) is switched from the lean air-fuel ratio to the stoichiometric air-fuel ratio, the delay time with respect to the switching of the required air-fuel ratio (see FIG. 6B) from the lean air-fuel ratio to the stoichiometric air-fuel ratio is not added to the switching of the target air-fuel ratio (see FIG. 6E) from the lean air-fuel ratio to the stoichiometric air-fuel ratio. That is, in the example illustrated in FIG. 6 in which the required air-fuel ratio (see FIG. 6B) is switched from the lean air-fuel ratio to the stoichiometric air-fuel ratio at the time t11, the target air-fuel ratio (see FIG. 6E) is also switched from the lean air-fuel ratio to the stoichiometric air-fuel ratio at the time t11.

In the example illustrated in FIG. 6, in correspondence to the change in the target air-fuel ratio (see FIG. 6E), at the time t11, the fuel injection amount (see FIG. 6H) increases from the value H1 to a value H2.

In the example illustrated in FIG. 6 in which the control device for the internal combustion engine of the first embodiment is applied, at the time t11, “No” is determined as the result in step S101 (see FIG. 5), and therefore, as shown in FIG. 67, the purge ratio constancy control (step S103 (see FIG. 5)) is continued. Specifically, the purge ratio (see FIG. 6G) is maintained at the value G1. In addition, the purge flow rate (the purge gas amount) (see FIG. 6I) which is the product of the purge ratio and the intake air amount starts to increase from the value I1.

Further, in the example illustrated in FIG. 6 in which the control device for the internal combustion engine of the first embodiment is applied, in a period while the estimated KL (see FIG. 6D) increases from the value D1 to the value D2, and in accompaniment therewith the fuel injection amount (see FIG. 6H) increases from the value H2 to a value H3, “No” is determined as the result in step S101 (see FIG. 5), and therefore, as shown in FIG. 6J, the purge ratio constancy control (step S103 (see FIG. 5)) is continued. Specifically, the target value of the purge ratio (see FIG. 6G) is maintained at the value G1. In addition, the purge flow rate (the purge gas amount) (see FIG. 6I) which is the product of the purge ratio and the intake air amount increases.

In addition, in the example illustrated in FIG. 6 in which the control device for the internal combustion engine of the first embodiment is applied, in a period after the estimated KL (see FIG. 6D) becomes constant at the value D2, and in accompaniment therewith the fuel injection amount (see FIG. 6H) becomes constant at the value H3, “No” is determined as the result in step S101 (see FIG. 5), and therefore, as shown in FIG. 6J, the purge ratio constancy control (step S103 (see FIG. 5)) is continued. Specifically, the target value of the purge ratio (see FIG. 6G) is maintained at the value G1. In addition, the purge flow rate (the purge gas amount) (see FIG. 6I) which is the product of the purge ratio and the intake air amount becomes constant at a value I2.

According to a second embodiment, the above described first embodiment and respective examples can also be appropriately combined.

What is claimed is:

1. A control device for an internal combustion engine comprising:
a cylinder;
an intake passage that is connected to the cylinder;
a fuel tank;
a purge passage that connects the intake passage and the fuel tank;
a purge control valve that is arranged in the purge passage;
a fuel injection valve; and
a throttle valve, wherein the control device comprises:
a purge flow rate constancy control portion that controls an opening degree of the purge control valve, so that a purge flow rate becomes constant, wherein the purge flow rate is a flow rate of a purge gas that is purged into the intake passage through the purge control valve, and
a fuel injection amount control portion that controls an amount of fuel that is injected from the fuel injection valve,
wherein a throttle opening degree control is started at a first time on the basis of a request for switching from a stoichiometric combustion to a lean combustion, wherein an air amount is switched from an air amount that is necessary for the stoichiometric combustion to an air amount that is necessary for the lean combustion in the throttle opening degree control at the first time,
wherein a fuel injection amount control is executed at a second time when a target air-fuel ratio is switched from a stoichiometric air-fuel ratio to a lean air-fuel ratio, wherein a fuel injection amount is switched from a fuel injection amount that is necessary for the stoichiometric combustion to a fuel injection amount that is necessary for the lean combustion in the fuel injection amount control at the second time,
wherein the control device executes the fuel injection amount control during a period from the first time to the second time in a state in which the purge flow rate is maintained at a value of the purge flow rate at the first time.

2. The control device for the internal combustion engine according to claim 1, further comprising
a purge ratio constancy control portion that controls a purge ratio so as to be constant, wherein the purge ratio is a ratio of the purge flow rate to an intake air amount,
wherein the control device starts a purge ratio constancy control after the second time.
